(19) United States
(12) Patent Application Publication
(10) Pub. No.: US 2003/0064352 A1
(43) Pub. Date: Apr. 3, 2003

(54) Method for gathering information about and formulating public policy to address societal problems

(76) Inventor: Mary M. Keller, Harker Heights, TX (US)

Correspondence Address: David G. Henry, 7th Floor, 900 Washington Avenue, P.O. Box 1470, Waco, TX, 77603-1470, US

(21) Appl. No.: 09/965,132

(22) Filed: Sep. 26, 2001

(51) Int. Cl. G09B 19/00

(52) U.S. Cl. 434/236

(57) ABSTRACT

The invention is of a method or process for presenting social or systemic problems to panels of experts and society leaders and seeking solution strategies by facilitating the application of the collective skills and resources of such persons upon the problems through implementation of such method or process. The method involves gathering relevant experts and persons of influence or power at a symposia, conducting general sessions with keynote speakers, discussing sub-issues in small group components of the attendees at-large, and later presenting, in panel-moderator format, one or more hypothetical scenarios which exemplify the problem(s) at-issue, followed by moderator and audience questions directed to the blue ribbon panel. Most events are electronically recorded and otherwise chronicled for later education, evaluation and/or use in prompting others of influence or power to move to action.

### BACKGROUND OF THE INVENTION

1. Field of the Invention

The present invention relates to conducting seminars or meetings directed to gathering information gathering initiating the formation of public policy for addressing societal problems.

2. Background Information

Some societal problems receive a great deal of attention from the news media, from public officials, universities and research organizations, private foundations, and the general public. Examples of such high-profile problems include: child abuse, risky behavior relating to STDs, spousal abuse, “deadbeat dads”, racial intolerance, and so forth. In such cases, sufficient attention and resources are focused on the problem that full understanding of the problem (to the current limits of understanding) and a generally agreed public policy approach for dealing with the problem tend to naturally flow from the attention and application of resources, whether or not the public policy is brought to fruition through appropriate action.

By contrast, certain other societal problems are so much lesser known, and receive virtually no media attention, that recognition and understanding by those in positions to address the problems are woefully inadequate. In such cases, the problems either remain at static levels, or worse, gain in prevalence or severity. Without an effective methodology for bringing such a problem to the attention of society leaders and field-appropriate experts, in a context where collective thought is forced to be focused on the problem and pressure to propose solutions is virtually mandated, those in a position to address the problem will likely “never get around to it.”

An example of a societal problem which has received virtually no significant attention relates to the emotional challenges and educational obstacles faced by children of active military personnel as they are repeatedly and frequently moved from one school to another during their school years.

Needs of America's children receive much attention in general, and policy and program efforts have been directed to some highly mobile populations specifically (such as migrant students). However, the unique educational needs of military-connected children notably absent from these discussions. While the sacrifices of military personnel are typically acknowledged and appreciated in our society, the sacrifices of the families—and particularly their children—are not. Moving from school to school raises a number of issues for these students, and it only becomes more complicated when the moves are to different states or even different countries.

The following are important circumstances which either give rise to, or are at least related to the problems (consequences) to be highlighted below:

1.3-1.4 million children, ages birth to 21 years, are dependants of U.S. active duty, uniformed service members.

The number of school-aged, military-connected students is estimated at 800,000. These children are educated in the public schools in the United States (600,000), in the Department of Defense (DoDEA) schools worldwide (100,000) and in other school settings (100,000).

Military-connected students move three times more frequently than their civilian counterparts, moving an average of once every 2.9 years, and attending between 6 and 9 different schools during the K through 12th grade years.

The vast majority of the military-connected K-12 students are dispersed among different 20 states.

On average the military-connected student attends school in a district where the military-connected child represents less than 25% of the enrollment.

Factors which greatly exacerbate the inherent upheaval of a family move for a school aged child include, but have repeated impact on military-connected children include:

Challenges related to the transfer and interpretation of school records.

Disparities in the ways in which schools and school systems organize time and course progressions (school year calendars, school day-schedules, and grade levels at which certain “core subjects” are covered, for example).

Disparities from one school system (or state) to another relating to graduation requirements, prerequisite requirements, grading variations, tiered diplomas, and state's or district's “high stakes” exit or advancement testing.

Disparate prerequisites for participation in extracurricular and enrichment programs.

Varying eligibility requirements for, and availability of, special education programs and variations in program availability and content.

Lack of consistent elementary and middle school opportunities for students to develop necessary academic concepts and skills.

Inadequate understanding by adults of the social and emotional needs of the student in transition or the military-connected student coping with separation from or deployment of a parent(s).

Absence of reliable presence of a child-centered climate of understanding and acceptance supported by a strong and meaningful partnership between military installations and the supporting school system(s).

After repeated and frustrating failures, persons directly affected by the plight of military-connected children came to the realization that the problems for their children would not be addressed in any effective way until persons with wide-spread credibility and appropriate expertise first recognized and understood the problem, and then applied their collective expertise toward attempting to address the problems. Achieving such objectives is, in a very real sense, more easily said than done. Studies go unread, except by their sponsors, letter writing campaigns often produce no results beyond responsive letters that the recipient (a gonvernmental official, for example) will “look into the situation”, and individual lobbying of influential people and experts for solutions to problems which are largely unnoticed or not understood appear largely ineffective.

The same barriers to effectively highlighting and seeking remedial measures come to bear, not just on the military-connected child education issues just discussed, but to any number of other social problems which do not share the proverbial limelight with the media or Hollywood luminaries, such as the above-mentioned cases of dread diseases and social injustices.

In view of the above, it would literally serve all humankind to provide a new and uniquely effective method or process by which societal problems are brought to the attention of persons who are best suited for solving them, and the collective expertise and resources of such persons are collectively focused in a manner that is likely to produce solution strategies and engender the commitment of persons with the influence and power to implement the strategies.

### SUMMARY OF THE INVENTION

In view of the foregoing, it is an object of the present invention to provide an improved method or process for presenting social or systemic problems to panels of experts and society leaders and seeking solution strategies by facilitating the application of the collective skills and resources of such persons upon the problems through implementation of such method or process.

In satisfaction of this object, the present invention provides a method by which a societal problem is “packaged” for presentation to panels of carefully selected experts and society leaders, and through the practice of which the expertise and/or power of such persons, as applicable to solution strategies for the problems, are collected in a medium for further study or implementation.

A specific sequence of steps and a method of presenting the subject problem to expert panelists are elemental to the present invention. The present method has proven uniquely effective in mobilizing power and resources against a problem to which none was effectively applied before, particularly for lack of information in the hands of the right people and of the effective coordination of such people in understanding, analyzing, and proposing solutions to such problems.

### BRIEF DESCRIPTION OF THE DRAWINGS OR EXHIBITS

Table 1 is a time-line in chart format showing the events and timing of events leading up to, including and following a round table process of the present invention.

Exhibit 1 are charts showing the physical layout (chairs, tables, cameras, etc.) for the Senior Leader Policy Forum component of the roundtable process.

Exhibit 2 is a specification sheet for audio-visual and props requirements for a roundtable process.

Exhibit 3 is a production plan, schedule and cost projection for the video and audio technical support aspects of a round table process symposium.

Exhibit 4 is an exemplary letter from a victim of the societal problem under review at a round table process of the present invention.

Exhibit 5 is an exemplary letter from an influential public figure (a governor in this case) which capsulizes the problem represented by the letter and its author, and inviting the panelists to form and participate in a “blue ribbon panel” for seeking solutions to the problem.

### DETAILED DESCRIPTION OF THE PREFERRED EMBODIMENT

The present invention is of a business method or process by which a societal problem is “packaged” for presentation to panels of experts and society leaders, and through the practice of which the expertise and/or power of such persons as applicable to solutions strategies for the problems are collected in a medium for further study or implementation.

The herein discussed specific implementation (embodiment, if you will) of the process or method of the present invention applies to the challenges and impediments faced by military-connected students as discussed above. However, it should be clearly understood that the processes described are equally applicable to any societal problem which: (1) lacks widespread attention and the associated public support and (2) requires the collective input of a number of persons having special expertise and/or considerable public or social power or authority to realistically address. In fact, the process can be applied to ANY societal or systemic problem, whether well-known or not, but its unique gift is in mobilizing power and resources against a problem to which none was effectively applied before, particularly for lack of information in the hands of the right people and of the effective coordination of such people in understanding, analyzing, and proposing solutions to such problems.

Referring to Table 1, a complete time line as is applicable to a round table process of the present invention which is directed to the military-connected child education issues discussed herein. The time line is important as a checklist for events and tasks which (or analogous counterparts in different to-be-addressed problem contexts) must take place or be accomplished for a round table process to properly function and to achieve the desired results. For roundtable processes directed to problems other than military-connected child education issues, the tasks and events corresponding to interactions with “DoD” as referenced in Table 1 will be with whatever sponsoring agency (if any) is involved for the particular issue at hand. References to “MCEC” in Table 1 refer to the Military Child Education Coalition (the producers or facilitator for the round table process, and the sponsor of the present invention).

The time line (or checklist) of Table 1 includes numerous individual items, but hereafter, the discussion will be limited to the primary components of the preparation for, conducting of, and follow-up after the roundtable process, which steps or events are beyond mere logistics as are common to any public gathering of multiple guests or participants.

The process begins by selecting a venue for the process, which will hereafter be referred to as the “roundtable process.” The venue must not only have some relevance to the problem to be addressed (close to a concentration of military-connected children, for example, if the problem is that described earlier in this disclosure), but also one to which desired participants will be willing and able to travel. Availability dates for the to-be-used facilities must be balanced with those scheduling complexities for would-be participants as can be reasonably anticipated. Of course, key participants (desired keynote speakers and persons with uniquely relevant expertise or authority) should be consulted for their scheduling constraints.

The roundtable process of the present invention involves one or more keynote speakers, certain panelists, a moderator, and audience members. For any roundtable process, one should include as keynote speakers, moderators, and panelists those who, at least collectively, possess applicable expertise or specific knowledge or experience, who are in positions to influence public opinion, who hold positions of public authority, and who are gifted in fashioning solution strategies for highly complex problems with, perhaps, multiple interconnected and independent causes or contributing factors. For the military child education issue, one would preferably seek to involve school board members (state and local); military personnel at command levels and positions to both have an interest in the problem at hand, and to likely be able to effect or facilitate solution strategies derived from the roundtable process; political figures with either broad political power (governor level, for example) or with specific authority relating to the problem-at-hand (education committee members in Congress or state legislatures, for example); prominent social leaders (noted philanthropists or prominent figures in industry); military parents; teachers; school counselors; influential members of the media with likely sympathies for the students at issue, and students.

Preceding the roundtable event, technical and logistical arrangements must be completed. Because of very specific characteristics of the preferred mode of a round table process according to the present invention, the physical and technical set-up is likewise very specific.

Attached as Exhibit 1 are charts showing the physical layout (chairs, tables, cameras, etc.) for the Senior Leader Policy Forum component of the roundtable process. Attached as Exhibit 2 is a specification sheet for audio-visual and props requirements for a roundtable process. Attached as Exhibit 3 is a production plan, schedule and cost projection for the video and audio technical support aspects of a round table process symposium.

The actual roundtable process proceeds as follows:

1. Invited guests check in at a registration desk and receive materials which describe, not only the time and places of events as would occur at any seminar or symposia, but both “makes the case” that the subject problem urgently requires attention (by giving statistics, anecdotal evidence, personal “snapshots” of victims, etc.) and states the naturally resulting mission or objective of the gathering. The materials will also include biographical sketches of the key participants, in part, to provide credibility for other participants and observers, and heighten the sense of importance of the event.

2. Attendees gather for a reception and dinner where the selected keynote speaker (a person with considerably relevant expertise relating to the problem at issue) welcomes attendees and explains the round table process and objectives of the roundtable event.

3. Attendees gather the following morning for breakfast and a general session meeting. The keynote speaker (the same as the preceding evening, or a different qualified person) explains in-depth the categories for discussion and any relevant information/research that pertains to the event.

4. Attendees go to separate rooms for a small group facilitated dialogue and an in-depth discussion about two topics which relate to the problem(s) under study such as, in the case of military-connected child education issues, the following topics:

a. Records, Calendars, Schedules

b. Graduation requirements

c. Community/Partnerships and Collaboration

d. Extracurricular and Enrichment opportunities

e. Social Emotional Needs

f. Special Programs

g. Elementary/middle school issues

Clips of the small group discussions are videotaped and pictures are taken of individuals. The highlights of the discussion are outlined and recorded on paper.

5. After small group discussions, the attendees gather for lunch and a general session. The keynote speaker addresses issues such as (in the present exemplary case) the education policy for that particular state and any relevant information to be conveyed to the attendees.

6. Attendees next gather for a Senior Leader Policy Forum involving the following characteristics:

Participants: The forum participants (panel) will have been selected according to the criteria described above in relation to interest, expertise, leadership, influence and power considerations. The panelists, representing a variety of perspectives, participate in an in-depth dialogue focused on the dimensions, response capability, and the policy contexts inherent in the problem under review (public education for military-connected children, for example).

Structure: The participants (14 to 18 participants) sit at a half moon shape table facing the moderator. The moderator is approximately 10 feet from the center of the moon shaped table facing the forum panel. The audience is behind the moderator facing the forum panel. The video crew is in the following locations: behind the audience facing the panel, to each side of the moderator facing the panel and moderator, and behind a full-length curtain facing the moderator.

Hypothetical Situation: A hypothetical situation which is representative of the problem under review is prepared for use at the forum. In the case of the military-connected child issues, the hypothetical is presented in the form of a letter from a hypothetical student named Joseph, who writes to a (hypothetical) Governor of Anystate (a copy of this exemplary letter is attached hereto as Exhibit 4). The Governor of Anystate writes a second letter (attached as Exhibit 5) inviting the panelists to the forum and serve as a blue ribbon task force to discuss the issues of the student's letter. [Note, that this and all other elements of the present method are readily adaptable to other social problems which can best be illustrated by the words of even a fictional victim of the problem at issue, such as, when chronic child support problems and the consequences are at issue, by having the letter, according to the hypothetical, being written by a child whose describes his or her plight which flows from a distant parent's refusal to pay child support.]

Process: A facilitator addresses the audience by introducing the hypothetical situation. The audience is directed to write questions at any time during the forum on a card provided for them and to pass it down to a staff member located at the end of the isle. The lights are dim and the video cameras are running. Lights are directed toward the panelists and moderator. Panelists and moderator have lapel microphones which are voice-activated. The moderator begins by reading the “Joseph letter”. The moderator then asks questions related to the issues of the letter and directs them to first one panelist, then another, according to each respective panelist's expertise or experience. The moderator may ask several panelists the same question or ask the panelist to interact with each other. The moderator continues this format until all related issues are discussed in full. The lights are then brought up. The facilitator announces that the audience question time has begun. The moderator directs one question at a time to a panelist according to his/her expertise. The moderator continues this format until time has expired (1.5 hours total). The facilitator introduces a keynote speaker who closes the forum with brief concluding comments.

7. An Executive Summary is written by MCEC and published to all attendees. It contains all of the following: photographs and quotes from keynote speakers; photographs, quotes and a synopsis of the small group discussions; photographs and quotes from the senior leader policy forum; photographs and synopsis of the student facilitated discussion; acknowledgments; and a look ahead to potential solutions and future round table locations.

The above-described process is a highly effective tool for focusing the attention of the right people on a societal problem, that is, the people who are in a position to best comprehend, understand, formulate solution strategies for, and influence others to effect solutions to complex problems. The process gathers such people in one place, promotes the interchange of their ideas and proposals, and essentially puts at least one victim of the problem under review “in their face” with the pressure of an on-looking audience serving to motivate the participants' best individual and collective performance in analyzing and proposing solutions to the problem at-hand.

The resulting written and audiovisual materials are useful both by participants who want to promote further action to address the problem(s) at-issue, and/or by sponsoring organizations for use in lobbying non-participating persons of power or influence for help in addressing the problem.

It is recommended that formal thank you notes or cards be sent to panel, keynote speaker and moderator participants to avoid alienating these people from further involvement. Also, some form of “certificate of attendance” may promote involvement, or at least serve to aid in excusing some participants from their regular work related duties.

An alternative version of a roundtable process (although not the preferred mode) may involve certain combinations of video conferencing or internet conferencing set-ups where (as one example) some or all panelists are in separate locations from each other and/or from the audience. Another variation may, instead of using a hypothetical letter from a victim of the problem(s) at issue, involve an actor (or a real victim) who might present their story to the panel in-person (or, at least, on video) for even more dramatic effect.

Although the invention has been described with reference to specific embodiments, this description is not meant to be construed in a limited sense. Various modifications to, or alternative embodiments of, the present invention will become apparent to persons skilled in the art upon the reference to the description of the invention. It is, therefore, contemplated that the appended claims will cover such modifications that fall within the scope of the invention.

TABLE 1
INVENTION (ROUND TABLE PROCESS) TIMELINE AND TASK
LIST

| | | | Enclosure # |
|---|---|---|---|
| | | Person(s) | Supporting |
| Date* | Task | Responsible** | Documents |
| −95 days | Find a site (hotel) w/speciflcations; lock-in Round | CP | 1 |
| | Table dates; confirm site visit date | | |
| −88 days | Develop detailed round table budget | CP, PC | 2 |
| −88 days | Determine audio/visual requirements | CP, AV | 3 (Hard Copy) |
| −88 days | Contact Chamber of Commerce or hotel Re: restaurant, | CP | |
| | city, and attractions brochures | | |
| −81 days | Teleconference with DoD - 0900 - 0900 | CH, PC, DoD | |
| −80 days | Determine & finalize pre-conference & invitation | PC, GA | 4 (Hard Copy) |
| | information | | |
| −80 days | Update certificate of attendance | GA | 5 (Hard Copy) |
| −80 days | Round Table IPR meeting - 0930 - 0930 | PC, CH, CP | |
| −75 days | Take pre-conference & invitation to printer | GA | 4 (Hard Copy) |
| −75 days | Deliver certificate to the printer | GA | 5 (Hard Copy) |
| −75 days | Teleconference with DoD - 1030 | PC, CH, DoD | |
| −82 to 85 | Site visit to hotel | CP, AV | |
| days | | | |
| −84 days | Order large round table envelopes | GA | 6 (Hard Copy) |
| −84 days | Coordinate web site info Re: registration | PC, WM | |
| −68 days | Identify State civilian invitee list (State education | PC, CH, CP | 7 |
| | policy makers, Superintendents and School Board | | |
| | Presidents of school districts that support military- | | |
| | connected students, | | |
| −68 days | Teleconference Round Table IPR-site visit - 1400 | PC, CH, CP, AV | |
| −67 days | Teleconference with DoD - 0900 | PC, CH, DoD | |
| −61 days | Face-to-face conference with DoD | PC, CH, DoD, DoD, | |
| | | CP, CP, VC | |
| −62 days | Get DoD approved invitee list (Senior Military Leaders) | PC, CH, DoD | 8 |
| −61 days | Round Table IPR meeting - 0930 | PC, CH, CP, CP | |
| −60 days | Mail pre−conference brochures & invitations | CL, CP, CP | |
| −60 days | Update MCEC CG/CSM letter | PC | 9A, 9B |
| −54 days | Teleconference with DoD - 0900 | PC, CH, DoD | |
| −54 days | Develop press release | PR | 10 |
| −54 days | Round Table IPR meeting - 0930 | PC, CH, CP, CP | |
| −53 days | Get DoD/MCEC contract signed | PC, CH, DoD | 11 (Hard Copy) |
| −53 days | Finalize and sign Hotel Contract | PC, CP | |
| −53 days | Contract with video crew | PC, AV | 12 (Hard Copy) |
| −53 days | Coordinate web site info Re: registration | PC, WM | |
| −49 days | Contact DoD Re: Mail pre-invite letters to Military | PC, CH, DoD | 9A, 9B |
| | Senior Leaders | | |
| −49 days | Teleconference with DoD - 0900 | PC, CH, DoD | |
| −47 days | Round Table IPR meeting - 0930 | PC, CH, CP, CP | |
| −27 days | Teleconference with DoD - 0900 | PC, CH, DoD | |
| −26 days | Round Table IPR meeting - 0930 | PC, CH, CP, CP | |
| −25 days | Gather & prepare read-ahead materials-generic | PC, GA | 14 (Hard Copy) |
| −25 days | Gather & prepare read-ahead materials-specific | PC, GA, CP | 15 (Hard Copy) |
| −25 days | Identify & contact VIPs; Conference Call with Local | PC, CH | |
| | Action Chairperson (volunteer) | | |
| −25 days | Call installation commanders | CH | |
| −25 days | Get entertainment (student based performance)- | CH, CP, LAC | |
| | Contact Local Action Chairperson (volunteer) | | |
| −25 days | Update facilitator training procedures | PC, FT, VC | 16A, 16B |
| −22 days | Contact superintendents Re: student participants | PC, LAC | |
| | & personally invite them | | |
| −22 days | Contact Local Action Chairperson; Send out Principal | CH, LAC | 18 |
| | Letter Re: student participants | | |
| −22 days | Compile break−out session participants & topics | CP | 17 |
| −21 days | Make flight/travel arrangements for staff & board | CP | |
| −20 days | Proofread read-ahead materials | PC, GA, CP, CP | 14, 15 |
| | | | (Hard Copy) |
| −20 days | Deliver read-ahead materials to printer | GA | 14, 15 |
| | | | (Hard Copy) |
| −20 days | Teleconference with DoD - 0900 | PC, CH, DoD | |
| −19 days | Need POC from installations & school districts | PC, CP | |
| −19 days | Identify forum participants | PC, CH | 19 |
| −19 days | Round Table IPR meeting - 0930 | PC, CH, CP, CP | |
| −19 days | Contact shuttle service for Round Table attendees to | CH, CP | |
| | get from nearest airport to site of Round Table- | | |
| | possibly get help from nearest military installation or | | |
| | school district | | |
| −18 days | Identify & invite facilitators | PC, CP, CP, LAC | 20 |
| −18 days | Get list of observers from DoD | PC, DoD | |
| −18 days | Gather & prepare Forum Participant Cover Letter, | CP | 32, 33, 34 |
| | Joseph Letter, and Governor Letter to accompany Read | | |
| | A-head material | | |
| −18 days | Gather and prepare cover letters to accompany read a- | CP | 35 (A-F) |
| | head materials to all categories of participants | | |
| −18 days | Mail read-ahead materials & press release to | CL | 10, 14, 15, |
| | attendees, forum participants & facilitators | | 32, 33, 34, |
| | | | 35 (A-F) |
| −18 days | Prepare name tags & place cards | CP | 22A, 22B |
| −18 days | Prepare conference working agenda | CP | 23 |
| −17 days | Practice what will take place at the Senior Leader | PC, CH | |
| | Policy Forum | | |
| −15 days | Identify & contact guest speakers; travel agendas | PC, CH | |
| −15 days | Send out press releases | PR, CL, CP, CP | 10 |
| −15 days | Round Table IPR meeting - 0930 | PC, CH, CP, CP | |
| −14 days | Prepare conference program | PC, GA | 24 (Hard Copy) |
| −14 days | Finalize hotel room arrangements | CP | |
| −14 days | Finalize banquet/break-out session room set-up | CP | 26 |
| −14 days | Select people to say a prayer before meals | CH, PC | |
| −13 days | Dress Rehearsal (Rock Drill) for Round Table event: | PC, CH, CP, CP, AV, | 23A, 23B |
| | verbal practice of event in chronological order | PR | |
| | (detailed) | | |
| −12 days | Teleconference with DoD - 0900 | PC, CH, DoD | |
| −12 days | Have directional signs & head table chart made | CP | 27 |
| −12 days | Proofread conference program | PC, GA, CP | 24 (Hard Copy) |
| −12 days | Deliver conference program to the printer | GA | 24 (Hard Copy) |
| −12 days | Round Table IPR meeting - 0930 | PC, CH, CP | |
| −11 days | Identify supplies/materials to be shipped | CP | |
| −7 days | Ship materials to hotel | CP | |
| −6 days | Teleconference with DoD - 0900 | PC, CH, DoD | |
| −4 days | Prepare head table & seating chart sheets | CP, VC, CH | 29 |
| −4 days | Finalize menu arrangements | CP | 30 |
| −4 days | Make dinner arrangements in the local area for STAFF | CP | |
| | (−1 day and +1 day) | | |
| −1 days | Advance team arrives | MCEC & DoD staff | |
| 0 days | Facilitators' training | FT | 20 |
| 0 days | Participants arrive; | MCEC & DoD staff | 31 |
| | Registration | | |
| Day 0 | Reception & Welcome dinner | MCEC & DoD staff | |
| +1 days | Break-out sessions | MCEC & DoD staff | 17 |
| +1 days | Round Table Forum | MCEC & DoD staff | 19, 32, 33, 34 |
| +2 days | After-action meeting | MCEC & DoD staff | 37 |
| +8 days | Mail thank you notes & personalized press release | PR, CL, CP | 38 (Hard |
| | | | Copy), 39 |
| +20 days | Prepare executive summary | PC, GA | 40 (Hard Copy) |
| +22 days | Proofread executive summary | PC, GA, CP | 40 (Hard Copy) |
| +26 days | Deliver executive summary to the printer | GA | 40 (Hard Copy) |
| +34 days | Mail executive summary to all participants | CL | |
| +34 days | Update MCEC web site with executive summary | WM | |

*Date = number of days associated (either before or after) with the first day of the Round Table Event (day 0)
**Persons Responsible have the following abbreviated titles:
PC = Project Coordinator
CP = Conference Planner
CH = Chairman of MCEC
VC = Vice Chairman of MCEC
DoD = Representative from the Department of Defense
GA = Graphic Artist
AV = Audio Visual Coordinator
CL = Clerk
WM = Webmaster
PR = Public Relations Coordinator
FT = Facilitator Trainer
LAC = Local Arrangements Chairperson (volunteer)

[image]

[image]

[image]

[image]

[image]

[image]

[image]

[image]

[image]

[image]

[image]

[image]

[image]

[image]

[image]

[image]

[image]

[image]

[image]

I claim:

1. A method for facilitating analysis and generation of solution strategies for a societal problem comprising the steps of:
gathering a plurality of panel group participants which includes persons of recognized expertise in the field of said societal problem, influential public figures, policymakers, and victims of said societal problem;
presenting a case study of a victim of the problem at issue to said panel group participants and to an audience watching said panel group participants;
requesting said panelists to present analysis of said hypothetical and to propose solutions to said problem as is reflected by said case study; and
electronically recording responses of said panelists.

2. The method of claim 1 wherein, before said presenting said case study, said panel participants are convened in two or more groups consisting of sub-sets of the entire panel, and facilitating discussion of issues relevant to said societal problem.

3. The method of claim 1 wherein said presenting a case study is accomplished by presenting a letter to said panel participants, which letter is represented to said panelists as being drafted by a victim of said societal problem and which letter explains the consquences of said societal problem to the author of said letter.
